(19) United States
(12) Patent Application Publication
(10) Pub. No.: US 2008/0021945 A1
(43) Pub. Date: Jan. 24, 2008

(54) METHOD OF PROCESSING SPATIAL-TEMPORAL DATA PROCESSING

(76) Inventors: James Hamilton, Brighton, MI (US); Matthew O'Donnell, (US)

Correspondence Address: SCHOX PLC, 209 N. MAIN STREET #200, ANN ARBOR, MI, 48104, US

(21) Appl. No.: 11/781,223

(22) Filed: Jul. 20, 2007

Related U.S. Application Data
(60) Provisional application No. 60/807,881, filed on Jul. 20, 2006.

(51) Int. Cl. G06F 17/10

(52) U.S. Cl. 708/300

(57) ABSTRACT

In one embodiment, the invention includes a method of formulating a parametric model from spatial-temporal data including fitting model parameters calculated from spatial-temporal data to at least one displacement model and calculating new spatial temporal data based on the model. In another embodiment, the invention includes a method of processing spatial-temporal data including filtering the spatial temporal data and assessing data quality based on data quality metrics.

### CROSS-REFERENCE TO RELATED APPLICATIONS

This application claims the benefit of U.S. Provisional Application No. 60/807,881 filed on 20 Jul. 2006 and entitled “Temporal Processing”, which is incorporated in its entirety by this reference.

### TECHNICAL FIELD

This invention relates generally to the ultrasound field, and more specifically to a new and useful method of image processing in the ultrasound field.

### BACKGROUND

Conventional ultrasound based tissue tracking systems produce two types of image products. The first type includes tissue displacement image products that describe tissue mechanical properties and that include displacement (axial and lateral), tissue velocity, strain (all components), strain magnitude, strain rate (all components), stain magnitude rate, correlation magnitude. The second type includes traditional image products that describe anatomical and functional characteristics, and that include B-mode, color flow (CF), M-mode, and Doppler. There is a need in the medical field to create a new and useful method to process these spatial-temporal data cubes. This invention provides such new and useful processing method.

### BRIEF DESCRIPTION OF THE FIGURES

FIG. 1 is a representation of spatial-temporal data as a data cube.

FIG. 2 is a schematic of the spatial-temporal data processing method of a first preferred embodiment.

FIG. 3 is a schematic of the spatial-temporal data processing method of a second preferred embodiment.

FIG. 4 is a schematic of the spatial-temporal data processing method of a third preferred embodiment.

FIG. 5 is a graph showing the fit of a sinusoidal model to tissue displacement data.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

As shown in FIG. 1, a spatial-temporal data cube preferably includes at least one of two types of image products: (1) Tissue displacement image products that describe tissue mechanical properties and that include displacement (axial and lateral), tissue velocity, strain (all components), strain magnitude, strain rate (all components), stain magnitude rate, correlation magnitude and (2) traditional image products that describe anatomical and functional characteristics, including B-mode, color flow (CF), M-mode, and Doppler. Any form of spatial-temporal data may, however, be used with the preferred embodiment of the invention. A spatial-temporal data cube includes a time series of image product spatial maps. Spatial-temporal (data cube) processing can be performed on real-time product stream or post acquisition on stored data products. Processing can be done on acoustic frames (i.e., sets of beams that compose a frame) or scan converted images (i.e., image product converted to physical reference frame—x,y coordinates). Processing parameters of products may be independent.

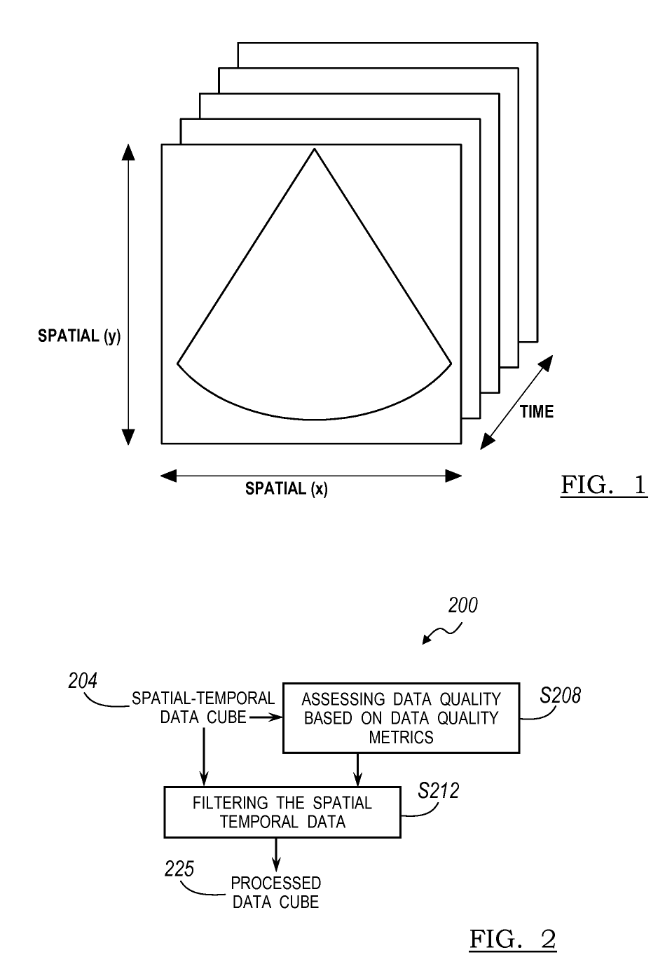

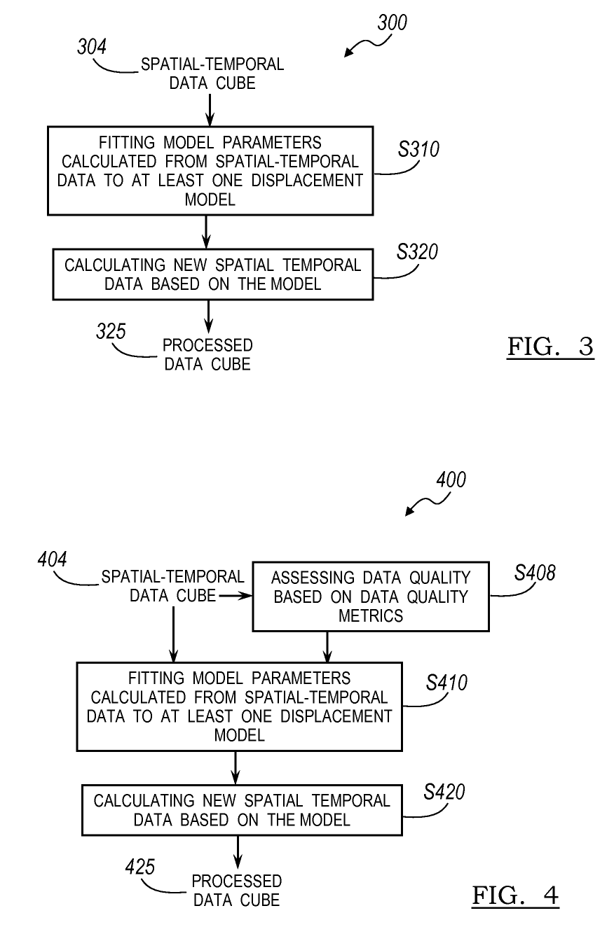

As shown in FIGS. 2-4, the preferred embodiments of the invention receive the input of a spatial-temporal data cube 204, and after temporal processing, output a processed data cube 225. As shown in FIG. 2, the first preferred method of the invention, which is used to process a spatial-temporal data cube 204, such as the data cube shown in FIG. 1, includes the steps of assessing data quality based on data quality metrics and filtering the spatial temporal data. Two additional preferred methods are shown in FIGS. 3-4, including the steps of fitting model parameters calculated from spatial-temporal data to at least one displacement model and calculating new spatial temporal data based on the model as shown in FIG. 3, and further adding the additional step of assessing data quality based on data quality metrics as shown in FIG. 4. While the invention provides advantages in the medical ultrasound field, the methods may be applied to any field where spatial-temporal data is processed.

As shown in FIG. 2, the method 200 of spatial-temporal data processing includes the steps of assessing the data quality based on data quality metrics S208 and filtering the spatial-temporal data S212, outputting a processed data cube 225.

Step S208 functions to evaluate the quality of the spatial-temporal data 205 such that the contribution of each sample on the model fit may be weighted based on data quality metrics (DQM). Each sample is preferably evaluated based on these data quality metrics, which may be used to identify poor samples in a spatial-temporal data product set. Identification can be a binary indicator (e.g., thresholding), weighting based on the sample DQM or combination. Poor samples may be culled and eliminated prior to spatial-temporal processing based DQM assessment, and may be replaced with a value determined by surrounding valid data (e.g., interpolation). Data quality weighting can be used to adjust the impact of samples on filter output. Many of the filtering techniques described below (e.g., Kalman, parametric modeling) may accommodate data quality weighting. Data quality metrics are preferably calculated for each sample or sub-set of samples of image region, forming DQM map. Preferably DQM's components include: Peak correlation, temporal and spatial variation (e.g., derivatives and variance) of tissue displacement, and spatial and temporal variation of correlation magnitude. Operational DQM may be individual or combination of preferable DQM components.

Step S212 functions to filter the spatial-temporal data 205. There are two preferred methods of temporal filtering data, but any method of temporal filtering may be used. Temporal finite impulse response filtering (FIR) is described by the following equation:

$${p}_{n}^{f} ( j ) = {\sum }_{k = - T / 2}^{k = T / 2} {c}_{k} {p}_{n} ( j - k )$$

where pₙ is the data product for the nth image pixel and ck is the sample weighting across temporal window of size T. The temporally filtered result is given by p_{fn}. Temporal infinite impulse response filtering (IIR) is described by the following equation:

$${p}_{n}^{f} ( j ) = {\sum }_{k = - T / 2}^{k = T / 2} {c}_{k} {p}_{n} ( j - k ) + {\sum }_{l = 1}^{l = τ} {b}_{l} {p}_{n}^{f} ( j - l )$$

This expression is similar to the FIR filter, with the addition of a weighted sum of previous outputs. Both may be spatially variant or invariant (e.g., different weightings given by c & b for each pixel). Temporal filtering is typically done to improve image quality (e.g. reduce noise), but may have other advantages.

Step S212 may also include space-time filtering. Space-time filtering is an extension of temporal FIR processing. The spatial-temporal data product cube is preferably convolved with a 3-D kernel, and can be equivalently done using 3D Fourier transform multiply. The filtering provides control of spatial and temporal characteristics simultaneously. For example, mechanical waves of tissue motion can be reduced or emphasized using space-time filtering.

Step S212 may also include recursive (Kalman) filtering. The Kalman filter is an efficient recursive filter that estimates the state of a dynamic system from a series of incomplete and noisy measurements. The dynamic system in this case is tissue mechanical properties (e.g., tissue displacement products). The weighting of each sample in the recursive filter may be based on a data quality metrics and acquisition time (time history).

As shown in FIG. 3, the method 300 of spatial-temporal data processing includes the steps of calculating model parameters from the spatial-temporal data S310 and calculating new spatial-temporal data based on the model S320, outputting a processed data cube 325.

Step S310 functions to calculate model parameters from the spatial-temporal data 304. The model parameters calculated are preferably amplitude, phase, and error. The model parameters may, however, be any suitable parameters that could be used in a parametric model. The model parameter(s) are preferably calculated based on the product data cube. For example, least square error (LSE) can be calculated from the data to determine model parameters.

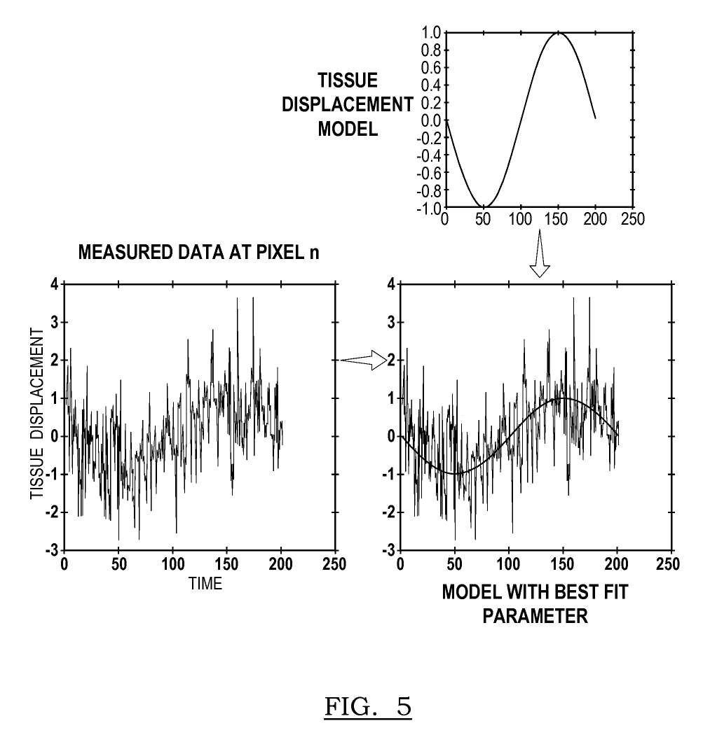

Step S310 preferably also functions to fit the model parameters to at least one displacement model. A parametric model or assumed form for tissue displacement products is preferably formulated. The parametric tissue model and estimated parameters are used to determine tissue displacement product at desired times and locations. As shown in FIG. 5, noisy displacement data for a single image pixel may be plotted against time. A sinusoidal displacement model is assumed, shown in the small upper panel. The best-fit amplitude and phase is calculated and the corresponding model output (shown as the dark line) with the measured data in the right panel. The smooth, high quality model based result represents the tissue displacement estimate at the pixel.

Step S320 functions to calculate new spatial-temporal data based on the model, to replace the original noisy data cube with a new processed data cube 325 calculated from the new parametric model. This new spatial temporal data is preferably calculated to reduce noise, but may also have other advantages.

As shown in FIG. 4, the second version of the method 400 of spatial-temporal data processing includes the steps of assessing data quality based on data quality metrics S408, calculating model parameters from the spatial-temporal data S410 and calculating new spatial-temporal data based on the model S420, outputting a processed data cube 425. Step S408 of the second version of the method 400 is preferably identical to Step S208 of the method 200. Steps S410 and S420 of the second version of the method 400 are preferably identical to Steps S310 and S320 of the method 300, except Step S410 may have modified inputs according to the assessed quality of the data in Step S408.

As a person skilled in the art will recognize from the previous detailed description and from the figures and claims, modifications and changes can be made to the preferred embodiments of the invention without departing from the scope of this invention defined in the following claims.

I claim:

1. A method of processing spatial-temporal data comprising:
filtering the spatial-temporal data; and
assessing data quality based on a data quality metric.

2. The method of claim 1 wherein the step of filtering the spatial-temporal data includes temporal filtering.

3. The method of claim 2 wherein the spatial-temporal data is filtered with at least one filter selected from the group consisting of: Finite Impulse Response Filter and Infinite Impulse Response Filter.

4. The method of claim 3 wherein the Finite Impulse Response Filter includes space-time filtering.

5. The method of claim 4 wherein the space-time filtering is performed with at least one method selected from the group consisting of: 3-D kernel convolution and 3-D Fourier transform multiplication.

6. The method of claim 1 wherein the step of filtering the spatial-temporal data includes a Kalman filter.

7. The method of claim 1 wherein the step of assessing data quality includes at least one method selected from the group consisting of: sample elimination, sample interpolation, sample weighting, sample thresholding, and a combination of sample weighting and sample thresholding.

8. The method of claim 7 wherein the step of assessing data quality includes assessing data quality based on at least one data quality metric selected from the group consisting of: peak correlation, spatial and temporal variation of displacement, and spatial and temporal variations of correlation magnitude.

9. The method of claim 1 wherein the step of assessing data quality includes assessing data quality based on at least one data quality metric selected from the group consisting of: peak correlation, spatial and temporal variation of displacement, and spatial and temporal variations of correlation magnitude.

10. The method of claim 1 wherein the spatial-temporal data is a real-time datastream.

11. The method of claim 1 wherein the spatial-temporal data is a stored datastream.

12. The method of claim 1 wherein the spatial-temporal data includes acoustic frames.

13. The method of claim 1 wherein the spatial-temporal data includes scan converted images.

14. A method of formulating a parametric model from spatial-temporal data comprising:
fitting model parameters calculated from spatial-temporal data to at least one displacement model; and
calculating new spatial temporal data based on the model.

15. The method of claim 14, further comprising the step of assessing data quality based on data quality metrics.

16. The method of claim 14 wherein the step of evaluating data quality includes at least one method selected from the group consisting of: sample elimination, sample interpolation, sample weighting, sample thresholding, or a combination of sample weighting and sample thresholding.

17. The method of claim 14 wherein the spatial-temporal data is a real-time datastream.

18. The method of claim 14 wherein the spatial-temporal data is a stored datastream.

19. The method of claim 14 wherein the spatial-temporal data includes acoustic frames.

20. The method of claim 14 wherein the spatial-temporal data includes scan converted images.
